(19) United States
(12) Patent Application Publication
(10) Pub. No.: US 2010/0143084 A1
(43) Pub. Date: Jun. 10, 2010

(54) TRANSPORTING CARRIER

(75) Inventors: Masanao MURATA, Ise-shi (JP); Takashi Yamaji, Ise-shi (JP)

Correspondence Address: YOUNG & THOMPSON, 209 Madison Street, Suite 500, Alexandria, VA, 22314, US

(73) Assignee: MURATEC AUTOMATION CO., LTD., Kyoto-shi (JP)

(21) Appl. No.: 12/629,355

(22) Filed: Dec. 2, 2009

(30) Foreign Application Priority Data
Dec. 4, 2008 (JP) 2008-309662

(51) Int. Cl. B66C 25/00; B66C 23/04; B66C 19/00

(52) U.S. Cl. 414/225.01

(57) ABSTRACT

A transporting carrier for transporting a transported object and for transferring it to a bringing-in/bringing-out part, which projects from a station and which brings in or out the transported object to or from the station or for transferring the transported object from the bringing-in/bringing-out part, the transporting carrier comprising: a main body part which has loading and accommodating parts and a lateral opening, the loading part being a space to load the transported object, the accommodating part being located under the loading part, the accommodating part being a space to accommodate the bringing-in/bringing-out part such that the bringing-in/bringing-out part is at least partially surrounded from lateral sides; a traveling device on the main body part; and a transferring device above the loading part of the main body part, for transferring the transported object between the loading part and the bringing-in/bringing-out part, with the bringing-in/bringing-out part in the accommodating part.

### BACKGROUND OF THE INVENTION

1. Field of the Invention

The present invention relates to a transporting carrier for transporting a transported object such as a container for accommodating or housing various substrates for manufacturing semiconductor devices and the like, to stations such as stockers. Here, the “transported object” in the present invention means a product, an intermediate product, a part, an article, a work, a partly-finished good, a good or the like (e.g. a semiconductor or LCD device), or means a box or container for containing such a product or the like (e.g. a container containing the semiconductor or LCD device), which has been transported or is to be transported by the transporting carriage. The load may be a carrier for containing an object to be carried such as a FOUP (Front Opening Unified Pod).

2. Description of the Related Art

As this type of transporting carrier, there is a vehicle for transporting the transported object in which the semiconductor substrate or the like is accommodated (PGV: Personal Guided Vehicle) by a worker operating it. The transported object is transported to a shelf on which the transported object is stored or to an apparatus for performing various operations such as manufacture and examination, and the transported object is transferred (i.e. unloaded). When the transported object is transferred, a transfer portion disposed on the transporting carrier such as a transfer arm is driven by the worker operating a lever, a handle, or the like, and the transfer is performed without the worker directly lifting the transported object (e.g. refer to Japanese Patent Publication No. 4092783).

However, for example, a clean room for semiconductor manufacture to which the transported object is transported by the transporting carrier is relatively expensive in construction cost, so that it is hard to ensure a sufficiently wide floor space in terms of cost. Thus, the width of a passage where the transporting carrier travels is relatively narrow, and if the transporting carrier, which is performing the transfer, exists in the passage, it possibly obstructs the passage of the worker and another transporting carrier. In other words, the transporting carrier in transfer may be an obstacle in the passage, and it possibly reduces the efficiency of various operations, which is technically problematic.

### SUMMARY OF THE INVENTION

It is therefore an object of the present invention to provide a transporting carrier which can easily perform a transfer operation without obstructing passage and operations even in a relatively narrow space.

The above object of the present invention can be achieved by a transporting carrier for transporting a transported object and for transferring the transported object to a bringing-in/bringing-out part, which is disposed to project from a station and which brings in or brings out the transported object to or from the station or for transferring the transported object from the bringing-in/bringing-out part, the transporting carrier provided with: a main body part which has a loading part and an accommodating part and which has a lateral opening, the loading part being a space to load the transported object, the accommodating part being located under the loading part, the accommodating part being a space to accommodate the bringing-in/bringing-out part such that the bringing-in/bringing-out part is at least partially surrounded from lateral sides; a traveling device disposed on the main body part; and a transferring device, which is disposed above the loading part of the main body part, for transferring the transported object loaded on the loading part to the bringing-in/bringing-out part or for transferring the transported object brought out from the bringing-in/bringing-out part to the loading part, with the bringing-in/bringing-out part accommodated in the accommodating part.

According to the transporting carrier of the present invention, the transported object is transported and brought in to the station on a transporting system in which semiconductor substrates or the like are automatically transported, for example, by a worker manually performing operations. Alternatively, the transported object brought out from the station is transferred to the transporting carrier and is transported to another station or the like. Incidentally, the “station” herein may be merely a storage location for storing the transported object, or an operation station or processing apparatus which can perform various operations on the transported object, or an apparatus or mechanism which also has a function of transferring or moving the transported object having different points to bring it in and bring it out, by some distance.

In the transporting system having the station, the transported object such as a FOUP (Front Opening Unified Pod) is transported by a transporting vehicle such as a vehicle and an OHT (Overhead Hoist Transport) which travels on a track, such as a rail, installed on or near the ceiling. The transporting vehicle transports the transported object among a plurality of stations disposed on the track. However, the transporting vehicle cannot transport the transported object when the operation of the system is stopped due to failures, maintenance, or the like. Moreover, the transporting vehicle cannot transport the transported object to a place where the track is not installed.

On the other hand, with the increased diameter of the semiconductor substrates or the like to be transported, the transported object to be transported is increased in size and in weight. Specifically, the FOUP for transporting a semiconductor substrate with a diameter of 450 mm is 500 mm high, 560 mm wide, and 350 mm deep, and it weights 20 kg or more. Thus, it is extremely hard for one worker to hold and transport the FOUP by oneself. Thus, as described above, if the transported object cannot be transported by the transporting vehicle in the system, there are possibly various disadvantages.

However, the transporting carrier of the present invention can transport the transported object, regardless of the operation of the system. In other words, even if the transporting system is stopped, the worker can easily transport the transported object. Moreover, even if a transportation origin or transportation destination is in the place where the track is not installed, it is possible to transport the transported object.

In particular, the transporting carrier of the present invention is provided with the main body part which has the loading part and the accommodating part and which has the lateral opening, wherein the loading part is a space to load the transported object, the accommodating part is located under the loading part, and the accommodating part is a space to accommodate the bringing-in/bringing-out part such that the bringing-in/bringing-out part is at least partially surrounded from the lateral sides. Incidentally, the “lateral sides” herein conceptually include forward, backward, and sideways with respect to the transporting carrier (i.e. horizontal direction), and in the broad sense, the “lateral sides” include various directions except the vertical direction. The main body part typically has a U-shape, so that it has a relatively large space in the inside, i.e. the loading part and the accommodating part. The main body part may be formed by combining pipe-shaped frames or by combining plates.

The main body part is provided with the travelling part such as a pulley, and the travelling part can travel on a transporting passage by the worker performing a pushing or pulling operation. Incidentally, the travelling device can electrically travel by providing a motor or the like. The transported object is transported by that the transporting carrier travels with the transported object loaded on the loading part of the main body part.

The transferring device is disposed above the loading part of the main body part, and when the transported object loaded on the loading part is transferred to the bringing-in/bringing-out part, the transfer operation is performed with the bringing-in/bringing-out part accommodated in the accommodating part. Moreover, even when the transported object brought out from the bringing-in/bringing-out part is transferred to the loading part of the transporting carrier, the transfer operation is performed with the bringing-in/bringing-out part accommodated in the accommodating part in the same manner. In the accommodation of the bringing-in/bringing-out part, the bringing-in/bringing-out part is accommodated into the main body part from the opening of the main body part. Incidentally, the “accommodation” herein is not limited to the state that the entire bringing-in/bringing-out part is covered with the main body part; however, it also includes the state that the bringing-in/bringing-out part is partially surrounded by the main body part.

By the bringing-in/bringing-out part being accommodated in the accommodating part of the main body part, the transporting carrier is brought close to the station side. In other words, it is possible to reduce the area that the transporting carrier occupies in the transporting passage or the like, by the amount that the accommodating part accommodates the bringing-in/bringing-out part. Thus, it is possible to effectively prevent the transporting carrier from obstructing the passage of the worker and another transporting carrier when the transporting object is transferred.

Moreover, in the present invention, the preferable transfer of the transported object is realized by bringing the transporting carrier close to the station side in the transfer. For example, in a case where the transfer is performed without the bringing-in/bringing-out part accommodated in the accommodating part, the transferring device is required to perform a hoist operation and an operation in the horizontal direction in order to transfer the transported object. However, the transporting carrier of the present invention can perform the transfer with the bringing-in/bringing-out part accommodated in the accommodating part, so that the transfer can be performed only by the hoist operation. In other words, by reducing the distance between the transporting carrier and the transported object, it is possible to transfer the transported object, more easily.

As explained above, according to the transporting carrier of the present invention, the main body part has the accommodating part for accommodating the bringing-in/bringing-out part. Thus, it is possible to easily perform the transfer operation without obstructing the passage and operations even in a relatively narrow space.

In one aspect of the transporting carrier of the present invention, the transferring device has: a holding device for holding the transported object; and a hoisting device for hoisting the holding device.

According to this aspect, the transferring device has the holding device, and the holding device holds the transported object or releases the held transported object, thereby performing the transfer. Moreover, the transferring device has the hoisting device in addition to the holding device. When the transported object is transferred, the holding device is hoisted (i.e. moved up or down) by the hoisting device. By this, it is possible to adjust the level of the holding device to a proper level in order to transfer the transported object. Therefore, it is possible to surely transfer the transported object.

In another aspect of the transporting carrier of the present invention, it is further provided with a safety catching device, which is disposed under the loading part of the main body part, for preventing the transported object from falling from the loading part by supporting the transported object loaded on the loading part from a lower side.

According to this aspect, the main body part is provided with the safety catching device, so that the transported object loaded on the loading part is prevented from falling. Specifically, the safety catching device is disposed under the loading part, and it prevents the transported object from falling from the loading part by supporting the transported object loaded on the loading part from the lower side. Incidentally, the “support” herein not only means that the loaded transported object is always supported but also includes the state that the loaded transported object is not supported until it is about to fall. In other words, the safety catching device may be always in contact with the transported object loaded on the loading part, or it may receive the transported object which is about to fall from the loading part on the lower side.

The transported object in transportation is prevented from falling by providing the safety catching device, so that it is possible to transport the transported object, more preferably. In particular, the aforementioned effect is remarkably produced when a precise member or apparatus which is sensitive to impact such as a semiconductor substrate is transported.

In an aspect in which the safety catching device is further provided, as described above, the safety catching device may be disposed in the accommodating part and is stored at a position at which the safety catching device does not obstruct the accommodation of the bringing-in/bringing-out part when the bringing-in/bringing-out part is accommodated in the accommodating part.

By virtue of such construction, the safety catching device is disposed in the accommodating part loaded under the loading part, so that it is possible to surely prevent the fall by supporting the transported object which possibly falls in the transportation, from the lower side. Moreover, particularly in this aspect, the safety catching device is stored at the position at which the safety catching device does not obstruct the accommodation of the bringing-in/bringing-out part when the bringing-in/bringing-out part is accommodated in the accommodating part. The safety catching device can move in accordance with the operation of a lever, a handle, or the like, and it is stored by the worker who operates the transporting carrier. Moreover, it may be automatically stored by detecting the accommodation by the accommodating part.

By the safety catching device being stored at the time of accommodation, it is possible to avoid that the accommodation of the bringing-in/bringing-out part is obstructed due to the presence of the safety catching device. Therefore, it is possible to perform the transportation and the transfer, more preferably.

In another aspect of the transporting carrier of the present invention, the transferring device can be rotated in a horizontal direction with respect to the main body part.

According to this aspect, by rotating the transferring device in the horizontal direction with respect to the main body part, it is possible to change the direction of the transferred transported object, as occasion demands. In other words, it is possible to change the direction of the transported object without rotating the main body part of the transporting carrier.

In the aforementioned structure, even if the direction of the transporting carrier is different between when the transported object is transferred from the bringing-in/bringing-out part and when the transported object is transferred to the bringing-in/bringing-out part, it is possible to complete the transfer without changing the direction of the transported object. Moreover, it is also possible to finely adjust the direction of the transferring device in a case where the transfer is not surely performed if the directions of the transferring device and the transported object do not match when the transported object is transferred from the bringing-in/bringing-out part. In other words, it is possible to perform the transfer operation, more preferably.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a top view conceptually showing the entire structure of a transporting system;

FIG. 2 is a perspective view showing a specific structure of a station;

FIG. 3 is a perspective view showing the structure of a transporting carrier in unloading in a first embodiment;

FIG. 4 is a perspective view showing the structure of the transporting carrier in loading in the first embodiment;

FIG. 5 is a side view (ver. 1) showing a specific structure of a hoist in the transporting carrier;

FIG. 6 is a side view (ver. 2) showing a specific structure of the hoist in the transporting carrier;

FIG. 7 is a side view (ver. 3) showing a specific structure of the hoist in the transporting carrier;

FIG. 8 is a partially enlarged view (ver. 1) showing a specific example of a holding part in the transporting carrier;

FIG. 9 is a partially enlarged view (ver. 2) showing a specific example of the holding part in the transporting carrier;

FIG. 10 is a partially enlarged view (ver. 3) showing a specific example of the holding part in the transporting carrier;

FIG. 11 is a perspective view showing a position relation between the transporting carrier and the station when a FOUP is brought in;

FIG. 12 is a side view showing the operation at the FOUP transfer of the transporting carrier in the first embodiment;

FIG. 13 is a side view showing the operation at the FOUP transfer of the transporting carrier in a comparative example;

FIG. 14 is a perspective view showing the position relation between the transporting carrier and the station when the FOUP is brought out;

FIG. 15 is a perspective view showing the structure of a holding part in a transporting carrier in a second embodiment;

FIG. 16 is a perspective view showing the structure of the transporting carrier in the second embodiment;

FIG. 17 is a side view showing the structure of a transporting carrier in a third embodiment;

FIG. 18 is a side view showing the operation at the FOUP transfer of the transporting carrier in the third embodiment;

FIG. 19 is a perspective view showing the structure of a transporting carrier in a fourth embodiment; and

FIG. 20 is a top view showing the placement of each station in the transporting system.

### DETAILED DESCRIPTION OF THE PREFERRED EMBODIMENT

Hereinafter, embodiments of the present invention will be explained with reference to the drawings.

### <Transporting System>

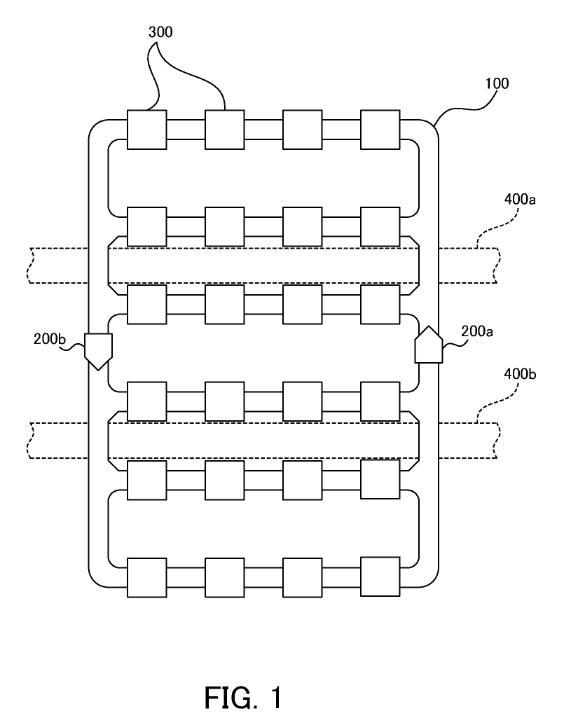

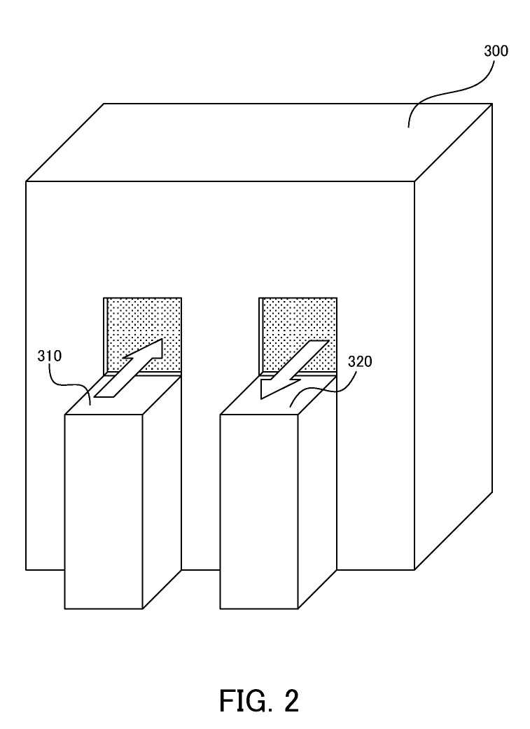

Firstly, the structure of a transporting system including stations which are transfer destinations of a FOUP transported by a transporting carrier in the embodiments will be explained with reference to FIG. 1 and FIG. 2. FIG. 1 is a top view conceptually showing the entire structure of a transporting system. FIG. 2 is a perspective view showing a specific structure of a station.

In FIG. 1, the transporting system is provided with a track 100, a plurality of vehicles 200, a plurality of stations 300, and transporting passages 400.

The track 100 is installed, for example, on or near the ceiling, and it is made of metal, such as aluminum and stainless. Incidentally, here, for convenience of explanation, the structure of the track 100 is shown as a relatively simple track; however, the actual track 100 may have a complicated structure having more branches and junctions.

Each of the vehicles 200 travels along the track 100, thereby transporting the FOUP which accommodates the semiconductor substrate or the like. In other words, the FOUP is one example of the “transported object” of the present invention. The vehicle 200 is installed with it hanging from the track 100, and it travels on the track 100 with a linear motor as power. Each of the vehicles 200 is controlled by a controller not illustrated or the like in its operation such as travel and transportation. Incidentally, here, for convenience of explanation, there are shown only two vehicles 200a and 200b on the track 100; however, typically, more (e.g. tens or hundreds of) vehicles 200 are provided.

The plurality of stations 300 are provided along the track 100, and each of the stations 300 can store the FOUP. Moreover, in the station 300, various operations can be performed on members such as the semiconductor substrate accommodated in the FOUP.

In FIG. 2, the station 300 is provided with a bringing-in part 310 and a bringing-out part 320 which are placed to project. The bringing-in part 310 has, for example, a belt conveyor or the like, and it brings the FOUP transferred from the transporting carrier into the station 300. The bringing-out part 320 has a belt conveyor or the like as in the bringing-in part 310, and it brings out the FOUP in the station 300 and displaces it to a transferable position, i.e. the transporting carrier. The bringing-in part 310 and the bringing-out part 320 are not necessarily separately provided as shown in FIG. 2. In other words, the bringing-in part 310 may be constructed to have the function of the bringing-out part 320. Moreover, two or more bringing-in parts 310 and two or more bringing-out parts 320 may be provided for one station 300.

Incidentally, here, this is not illustrated, but the station 300 is provided with a bringing-in part and a bringing-out part for bringing in and out the FOUP with respect to the vehicle 200, in addition to the bringing-in part 310 and the bringing-out part 320 described above.

Back in FIG. 1, the transporting passages 400 are passages for the transporting carrier traveling, and they are provided between the plurality of stations 300. The transporting carrier travels on the transporting passages 400, thereby transporting the FOUP, if the system is stopped and if the vehicles 200 cannot travel or in similar cases. Moreover, the transporting passages 400 also function as passages for a worker performing a maintenance operation or the like for the transporting system.

### <Transporting Carrier>

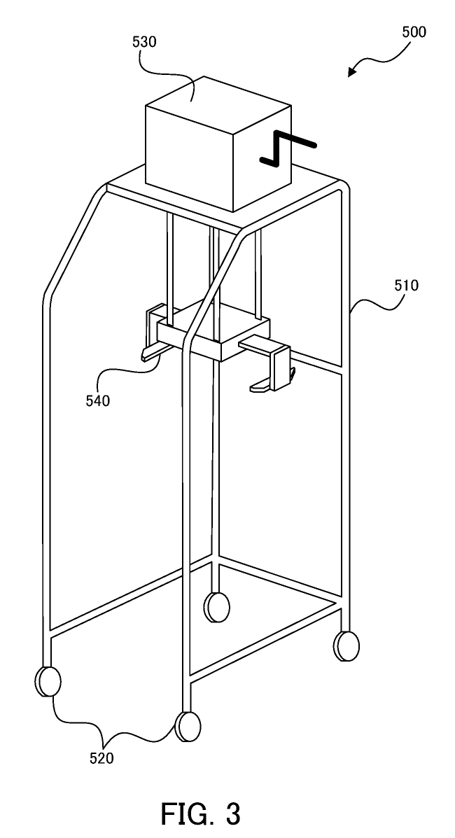

Hereinafter, the transporting carrier in the embodiments will be explained with reference to FIG. 3 to FIG. 18.

### First Embodiment

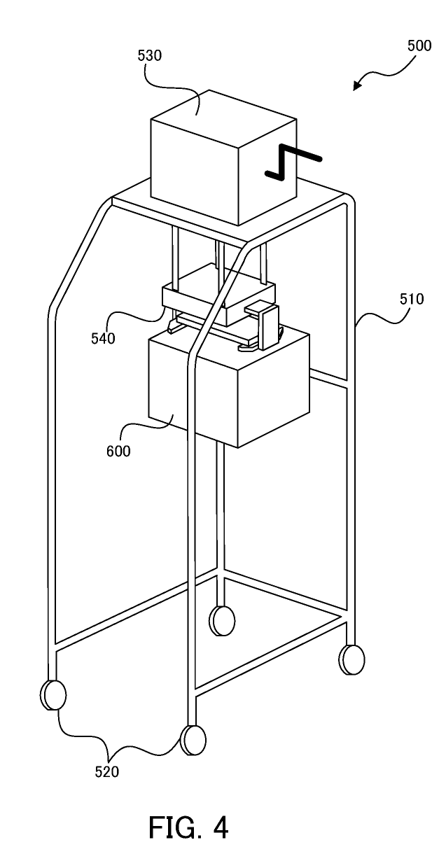

Firstly, the structure of the transporting carrier in a first embodiment will be explained with reference to FIG. 3 and FIG. 4. FIG. 3 is a perspective view showing the structure of the transporting carrier in unloading in the first embodiment. FIG. 4 is a perspective view showing the structure of the transporting carrier in loading in the first embodiment.

In FIG. 3, a transporting carrier 500 in the first embodiment is provided with a main body 510, a roller 520, a hoist 530, and a holding part 540.

The main body 510 is a frame made of metal such as aluminum and iron, and it has a U shape, so that it has a relatively large space in the inside. In the space within the main body, a loading part and an accommodating part are included, wherein the loading part is a space for loading the FOUP which is the transported object and the accommodating part is a space for accommodating the bringing-in part 310 and the bringing-out part 320 in the station 300.

The roller 520 is one example of the “traveling device” of the present invention, and it rotates to enable the transporting carrier 500 to travel. Incidentally, the roller 520 herein is constructed to be rotated by the worker performing an operation of pushing or pulling the transporting carrier 500; however, the roller 520 may be constructed to be rotated by an electric motor or the like.

The hoist 530 is one example of the “hoisting device” of the present invention, and it can move up and down the holding part 540 described later with respect to the main body 510. By the hoist operation by the hoist 530, the holding part 540 is adjusted to be at a proper level for gripping the FOUP. The specific structure of the hoist 530 will be detailed later.

The holding part 540 is one example of the “holding device” of the present invention, and it can hold the FOUP. By the FOUP being held by the holding part 540, the FOUP is loaded on the transporting carrier 500. The specific structure of the holding part 540 will be detailed later.

In FIG. 4, a FOUP 600 loaded on the transporting carrier 500 is accommodated in the space within the main body 510, with it held by the holding part 540, as shown in the drawing. In other words, the space in which the FOUP 600 is accommodated in the drawing is the loading part in the main body 510, and the space located under the FOUP 600 is the accommodating part. The accommodation of the bringing-in part 310 and the bringing-out part 320 into the accommodating part will be detailed when the transfer operation is explained.

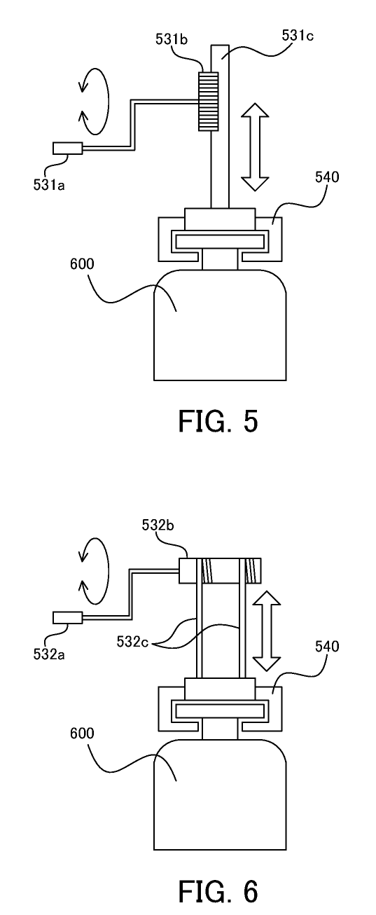

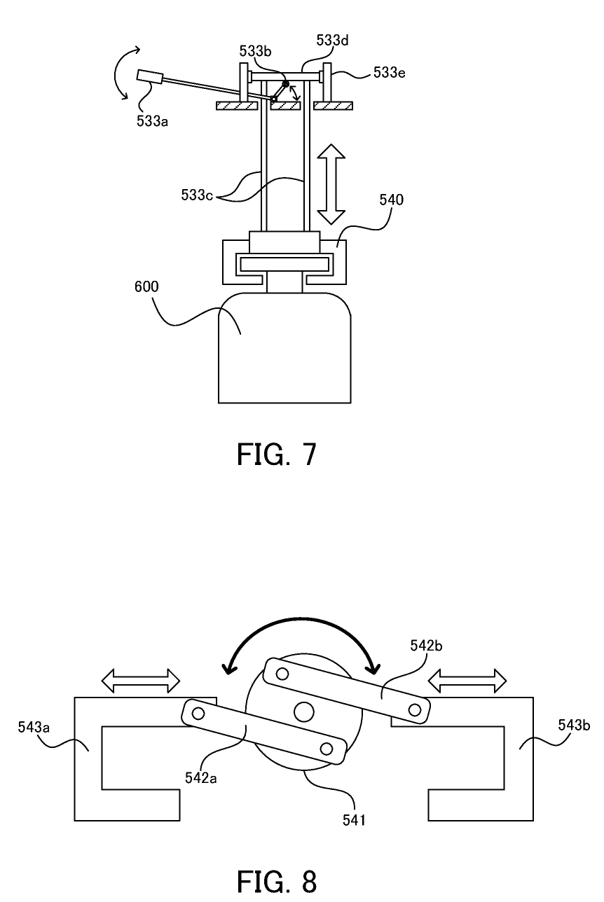

Next, the specific structure of the hoist 530 described above will be explained with reference to FIG. 5 to FIG. 7. Each of FIG. 5 and FIG. 7 is a side view showing the specific structure of the hoist in the transporting carrier.

In FIG. 5, the hoist 530 is provided, for example, with a hoist handle 531a, a hoist pinion 531b, and a hoist rack 531c. In the hoist, the worker operates the hoist handle 531a, thereby rotating the hoist pinion 531b and moving the hoist rack 531c in the vertical direction. By this, the holding part 540 mounted on the hoist rack 531c is hoisted.

In FIG. 6, the hoist 530 is provided with a hoist handle 532a, a belt wind-up part 532b, and a hoist belt 532c. In this case, by the worker operating the hoist handle 532a, the belt wind-up part 532b is rotated, and the hoist belt 532c is wound up on the belt wind-up part 532b or is wound off. By this, the holding part 540 mounted on the hoist belt 532c is hoisted.

In FIG. 7, the hoist 530 may be provided with a hoist handle 533a, a hoist driving part 533b, a hoist belt 533c, a hoist support part 533d, and a linear guide 533e. In this case, the worker operates the hoist handle 533a, thereby driving the hoist driving part 533b. By the hoist driving part 533b being driven, the hoist support part 533d is displaced in the vertical direction along the linear guide 533e. By this, the holding part 540 mounted on the hoist support part 533d is hoisted through the hoist belt 532c.

Incidentally, the structure of the hoist 530 exemplified here is merely one example. Even if the hoist 530 having a different structure is used, it is possible to realize the transporting carrier 500 in the embodiment described above.

Next, the specific structure of the holding part 540 driven by the hoist 530 described above will be explained with reference to FIG. 8 to FIG. 10. Each of FIG. 8 to FIG. 10 is a partially enlarged view showing the specific example of the holding part in the transporting carrier.

In FIG. 8, the holding part 540 is provided, for example, with a rotation driving device 541, two connection plates 542a and 542c, and two grip parts 543a and 543b. When the FOUP 600 is held, the worker operates a control (not illustrated) mounted on the rotation driving part 541, thereby driving the connection plates 542a and 542c, and along with this, the grip parts 543a and 543b perform an open/close operation. In the structure shown in FIG. 8, the grip parts 543a and 543b are opened by turning the rotation driving part 541 to the right, and the grip parts 543a and 543b are closed by turning the rotation driving part 541 to the left.

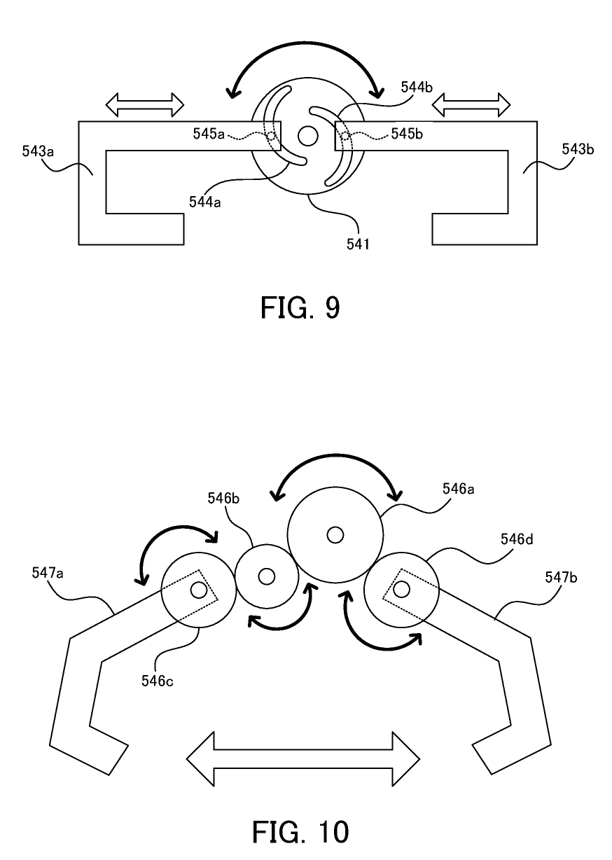

In FIG. 9, the holding device 540 may be provided with a rotation driving part 541 having two guide grooves 544a and 544b, a grip part 543a having a connection part 545a, and a grip part 543b having a connection part 545b. In this case, by operating a control or the like mounted on the rotation driving part 541, the connection parts 545a and 545b are displaced along the guide grooves 544a and 544b, and the grip parts 543a and 543b perform the open/close operation. In the structure shown in FIG. 9, the grip parts 543a and 543b are closed by turning the rotation driving part 541 to the right, and the grip parts 543a and 543b are opened by turning the rotation driving part 541 to the left.

In FIG. 10, the holding part 540 may be provided with four holding pinions 546a, 546b, 546c, and 546d, which engage with each other, and two grip parts 547a and 547b. In this case, by operating a control or the like mounted on the holding pinion 546a, the other holding pinions 546b, 546c, and 546d are rotated, and the grip parts 547a and 547b perform the open/close operation. Incidentally, the grip parts 547a and 547b in FIG. 10 are opened and closed by the rotary motion, which is different from the grip parts 543a and 543b in FIG. 8 and FIG. 9, so that they have a different shape. In the structure shown in FIG. 10, the grip parts 547a and 547b are opened by turning the holding pinion 546a to the right, and the grip parts 547a and 547b are closed by turning the holding pinion 546a to the left.

Incidentally, the structure of the holding part 540 exemplified here is merely one example. Even if the holding part 540 having a different structure is used, it is possible to realize the transporting carrier 500 in the embodiment described above.

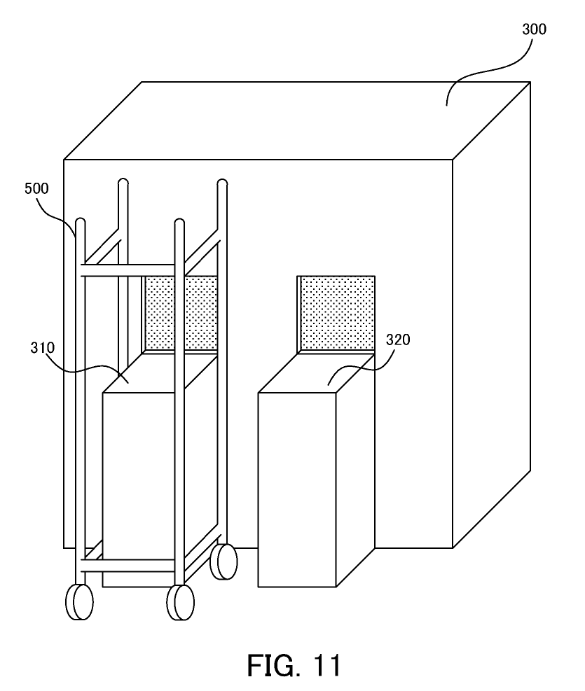

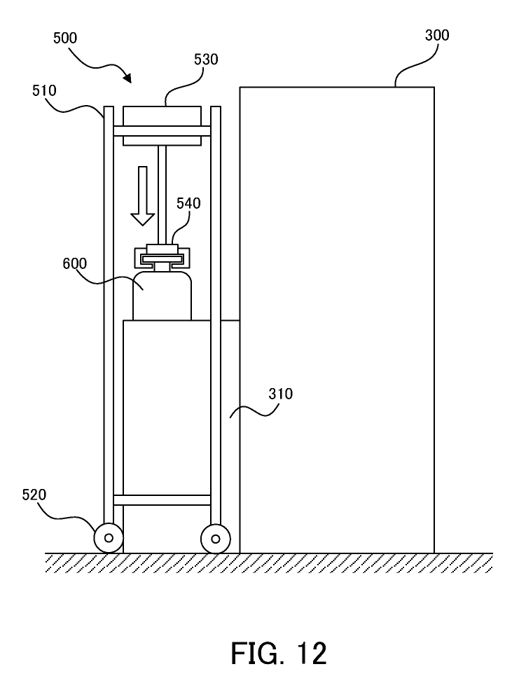

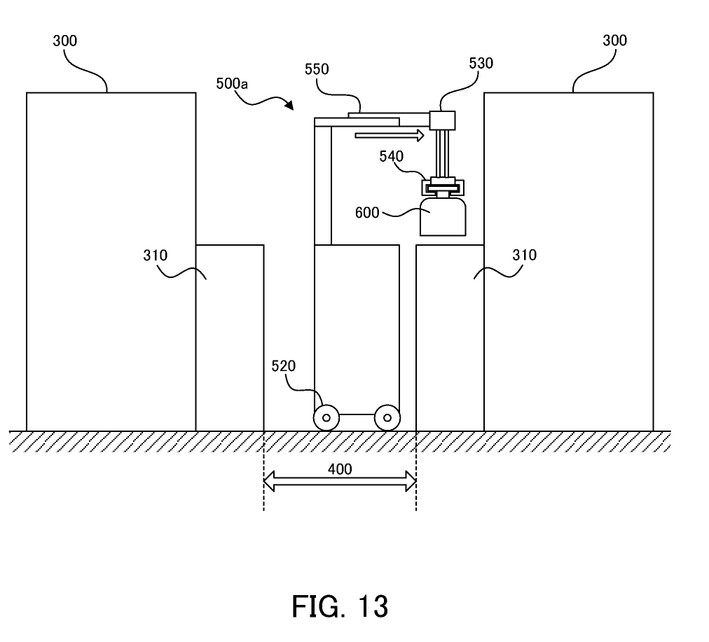

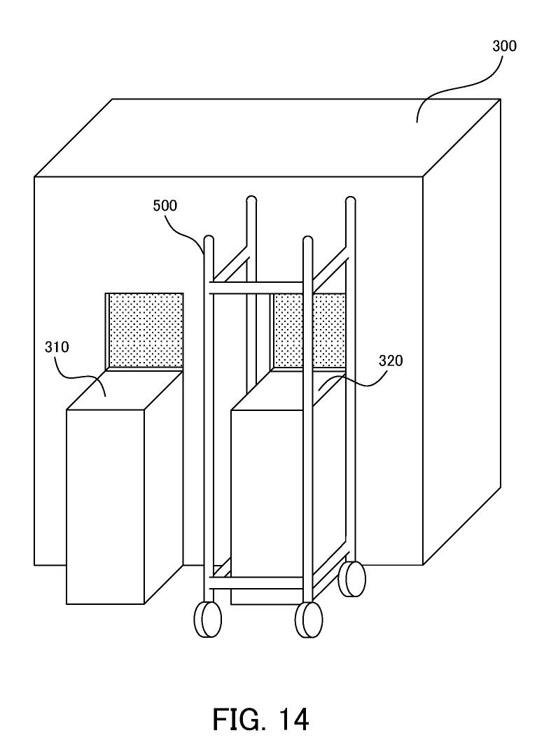

Next, with reference to FIG. 11 to FIG. 14, an explanation will be given on the operation in the transfer of the FOUP 600 of the transporting carrier 500 in the first embodiment. FIG. 11 is a perspective view showing a position relation between the transporting carrier and the station when the FOUP is brought in. FIG. 12 is a side view showing the operation at the FOUP transfer of the transporting carrier in the first embodiment. FIG. 13 is a side view showing the operation at the FOUP transfer of the transporting carrier in a comparative example. FIG. 14 is a perspective view showing the position relation between the transporting carrier and the station when the FOUP is brought out. Incidentally, in FIG. 11 to FIG. 14, for convenience of explanation, the illustration of the detailed members of the transporting carrier shown in FIG. 3 and FIG. 4 or the like is omitted, as occasion demands. The same is true for the drawings hereinafter.

In FIG. 11 and FIG. 12, when the FOUP 600 in the transporting carrier 500 in the first embodiment is brought in, the bringing-in part 310 is accommodated in the accommodating part of the transporting carrier 500. In other words, the main body 510 of the transporting carrier 500 surrounds the bringing-in part 310 from the lateral sides. When the loaded FOUP 600 is transferred to the bringing-in part 310, as shown in FIG. 12, the holding part 540 goes down by driving the hoist 530 to place the FOUP 600 on the bringing-in part 310. Incidentally, in the transfer, the roller 520 is fixed by a stopper or the like not to be rotated.

In FIG. 13, in a case where the FOUP 600 is transferred by a transporting carrier 500a which cannot accommodate the bringing-in part 310, the transporting carrier 500a occupies a larger space in the transporting passage 400 by the amount that the transporting carrier 500a cannot accommodate the bringing-in part 310. As a result, a space for the worker who operates the transporting carrier 500a in the transporting passage 400 and a space for the worker who tries to walk on the transporting passage 400 are extremely limited. Therefore, in the aforementioned case, there are possibly various practical disadvantages such as a reduction in working efficiency.

In contrast, in the transporting carrier 500 in the embodiment, the bringing-in part 310 is accommodated in the main body 510 of the transporting carrier 500 as shown in FIG. 11 and FIG. 12, so that it is possible to sufficiently ensure the space of the transporting passage 400. Therefore, it is possible to preferably perform the transfer operation even in a relatively narrow space.

Moreover, in the case shown in FIG. 13, the holding part 540 in the transporting carrier 500a is required to perform not only the hoist operation by the hoist 530 but also an operation in the horizontal direction by the arm 550. With regard to this, the transporting carrier 500 in the embodiment can transfer the FOUP 600 with it accommodating the bringing-in part 310, so that if the hoist operation in the hoist 530 can be performed, the operation in the horizontal direction by the arm 550 is not necessarily performed. Thus, it is possible to realize the transfer of the FOUP 600 in a relatively simple structure. Moreover, it is also possible to reduce a time required for the transfer of the FOUP 600.

In FIG. 14, when the FOUP 600 in the transporting carrier 500 in the first embodiment is brought out, the bringing-out part 320 is accommodated in the accommodating part of the transporting carrier 500. In other words, the main body 510 of the transporting carrier 500 surrounds the bringing-out part 320 from the side. Thus, as in the bringing-in shown in FIG. 11 and FIG. 12, it is possible to preferably transfer the FOUP 600.

As explained above, according to the transporting carrier 500 in the first embodiment, the main body 510 has the accommodating part for accommodating the bringing-in part 310 and the bringing-out part 320, so that it is possible to easily perform the transfer operation without obstructing the passage and operations even in a relatively narrow space.

### Second Embodiment

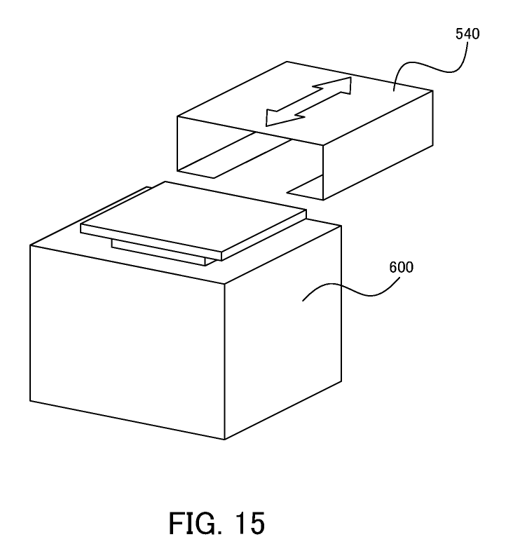

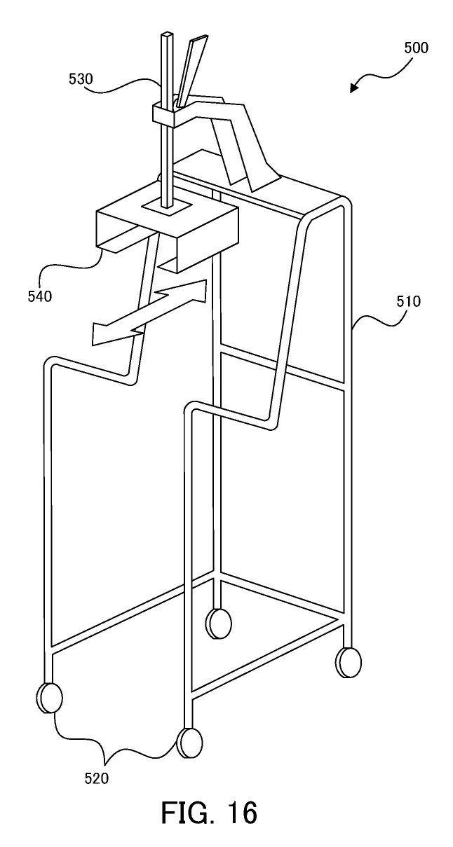

Next, a transporting carrier in a second embodiment will be explained with reference to FIG. 15 and FIG. 16. FIG. 15 is a perspective view showing the structure of a holding part in the transporting carrier in the second embodiment. FIG. 16 is a perspective view showing the structure of the transporting carrier in the second embodiment. Incidentally, in the second embodiment, the structure of the holding part is different from that in the first embodiment described above, and the other structures or the like are substantially the same. Thus, in the second embodiment, the parts different from those in the first embodiment will be explained in detail, and the explanation of the other overlapping parts will be omitted, as occasion demands. Moreover, in FIG. 15 and FIG. 16, the same constituents as those in the first embodiment shown in FIG. 3 and FIG. 4 or the like will carry the same referential numerical.

In FIG. 15, the transporting carrier 500 in the second embodiment is formed such that the holding part 540 has a shape shown in the drawing, and the holding part 540 itself is not provided with a driving part unlike the holding part 540 in the first embodiment (refer to FIG. 8 to FIG. 10). When the FOUP 600 is held by the holding part 540, the holding part 540 is slid in the horizontal direction (i.e. in an arrow direction in the drawing), by which one portion of the holding part 540 is fit into a gap between the handle and the main body of the FOUP 600.

In FIG. 16, the transporting carrier 500 in the second embodiment can be realized in a relatively simple structure as the holding part 540 itself does not have to be provided with a driving part as described above. In other words, if the hoist 530 for moving up and down the holding part 540 is provided, it is possible to surely transfer the FOUP 600.

When the FOUP 600 is loaded, the holding part 540 holds the FOUP 600 by displacing the transporting carrier 500 with the roller 520. More specifically, firstly, the levels of the FOUP 600 and the holding part 540 are adjusted by the hoist 530, and then, the transporting carrier 500 travels on the FOUP 600 side with the roller 520 and it holds the FOUP 600. Then, by the hoist 530 moving up the holding part, the FOUP 600 is loaded on the transporting carrier 500. Incidentally, when the loaded FOUP 600 is brought in, it is possible to surely transfer the FOUP 600 to the station 300 by performing the reverse operation of the aforementioned operation.

As explained above, according to the transporting carrier 500 in the second embodiment, it is possible to further simplify the structure of the transporting carrier.

### Third Embodiment

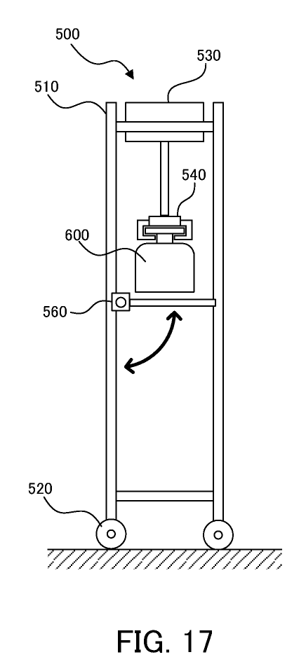

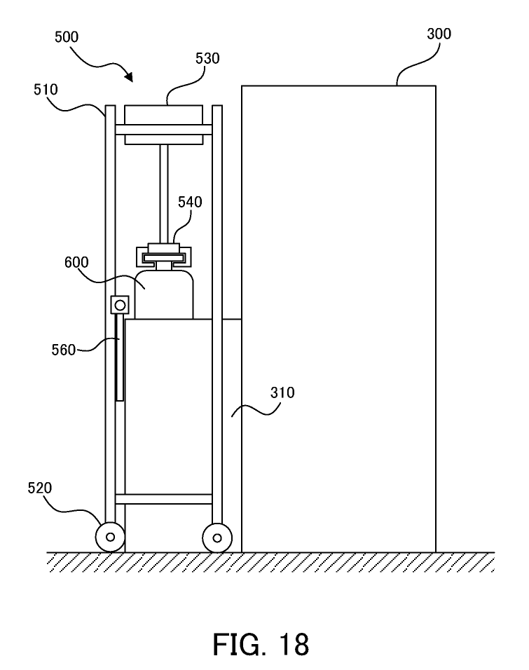

Next, a transporting carrier in a third embodiment will be explained with reference to FIG. 17 and FIG. 18. FIG. 17 is a side view showing the structure of the transporting carrier in the third embodiment. FIG. 18 is a side view showing the operation at the FOUP transfer of the transporting carrier in the third embodiment. Incidentally, the third embodiment is different from the first and second embodiments described above in that a safety catcher is provided, and the other structures or the like are substantially the same. Thus, in the third embodiment, the parts different from those in the first and second embodiments will be explained in detail, and the explanation of the other overlapping parts will be omitted, as occasion demands. Moreover, in FIG. 17 and FIG. 18, the same constituents as those in the first embodiment shown in FIG. 11 or the like will carry the same referential numerical.

In FIG. 17, the transporting carrier 500 in the third embodiment is provided with a safety catcher 560 for preventing the loaded FOUP 600 from falling, in addition to the structures of the first and second embodiments described above.

The safety catcher 560 is one example of the “safety catching device” and is disposed under the loading part of the main body 510. The safety catcher 560 is formed, for example, as a plate-like member, and it prevents the fall by supporting the loaded FOUP 600 from the lower side.

In FIG. 18, the safety catcher 560 is stored at a position at which it does not obstruct the accommodation when the bringing-in part 310 or the bringing-out part 320 is accommodated in the accommodating part. Specifically, the safety catcher 560 can move in accordance with the operation of a lever, a handle, or the like. When the FOUP 600 is transferred, the safety catcher 560 is stored at a position at which it is not in contact with the bringing-in part 310, as shown in FIG. 18.

By the safety catcher 560 being stored in the accommodation, it is possible to avoid that the accommodation of the bringing-in part 310 or the bringing-out part 320 is prevented due to the presence of the safety catcher 560. Therefore, it is possible to preferably perform the transportation and the transfer.

As explained above, according to the transporting carrier 500 in the third embodiment, the safety catcher 560 is provided, so that it is possible to prevent the FOUP 600 in transfer from falling. In particular, the aforementioned effect is remarkably produced when a precise member or apparatus which is sensitive to impact such as a semiconductor substrate is transported.

### Fourth Embodiment

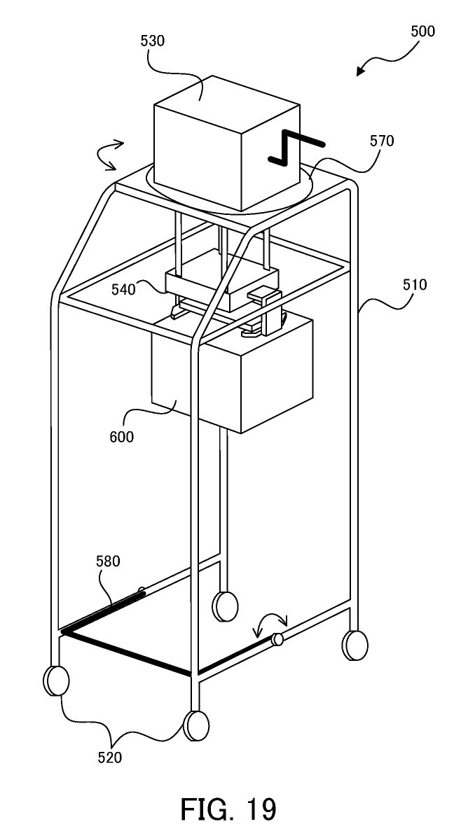

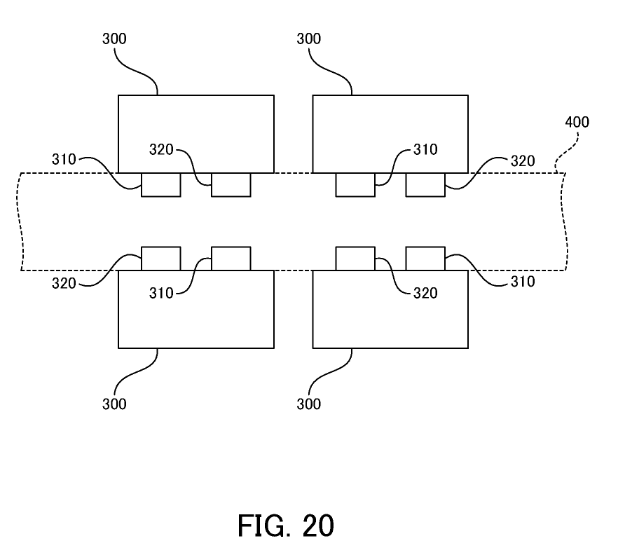

Next, a transporting carrier in a fourth embodiment will be explained with reference to FIG. 19 and FIG. 20. FIG. 19 is a perspective view showing the structure of the transporting carrier in the fourth embodiment. FIG. 20 is a top view showing the placement of each station in the transporting system. Incidentally, the fourth embodiment is different from the aforementioned embodiments described above in that the transferred FOUP can be rotated, and the other structures or the like are substantially the same. Thus, in the fourth embodiment, the parts different from those in the first to third embodiments will be explained in detail, and the explanation of the other overlapping parts will be omitted, as occasion demands. Moreover, in FIG. 19 and FIG. 20, the same constituents as those in the first embodiment shown in FIG. 1 and FIG. 4 or the like will carry the same referential numerical.

In FIG. 19, the transporting carrier 500 in the fourth embodiment is provided with a turn table 570 for rotating the hoist 530 and the holding part 540. The turn table 570 can be rotated in the horizontal direction and can change the direction of the hoist 530 and the holding part 540.

The transporting carrier 500 in the fourth embodiment is further provided with a rotation reinforcement bar 580. By rotating the rotation reinforcement bar 580 and changing its direction, it is possible to change the direction of the opening of the main body 510 of the transporting carrier 500. In other words, it is possible to change the direction of accommodating the bringing-in part 310 and the bringing-out part 320 into the accommodating part of the transporting carrier 500 by 180 degrees. By combining the rotation reinforcement bar 580 and the rotation of the turn table 570 described above, it is possible to perform the transfer operation on the FOUP 600 without regard to the front and back of the transporting carrier 500. Incidentally, the rotation reinforcement bar 580 is to keep the strength of transporting carrier 500, and it is not necessarily provided if the strength is sufficiently ensured.

As shown in FIG. 20, the transporting carrier 500 in the fourth embodiment produces a remarkable effect if the transporting passage 400 is relatively narrow and if the bringing-in part 310 and the bringing-out part 320 are disposed to be opposed to each other in each station 300. Specifically, if the FOUP is transferred between the bringing-in part 310 and the bringing-out part 320 which are opposed to each other, it is possible to perform the transfer without rotating the transporting carrier 500 (i.e. only by translating it). Moreover, the turn table 570 can be also used for the adjustment or the like of the direction of the FOUP 600 which is about to be transferred with the holding part 540.

As explained above, according to the transporting carrier 500 in the fourth embodiment, it is possible to perform the transfer operation on the FOUP 600, more preferably, by providing the turn table 570.

The invention may be embodied in other specific forms without departing from the spirit or essential characteristics thereof. The present embodiments are therefore to be regarded in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2008-309662 filed on Dec. 4, 2008 including the specification, claims, drawings and summary is incorporated herein by reference in its entirety.

What is claimed is:

1. A transporting carrier for transporting a transported object and for transferring the transported object to a bringing-in/bringing-out part, which is disposed to project from a station and which brings in or brings out the transported object to or from the station or for transferring the transported object from the bringing-in/bringing-out part, said transporting carrier comprising:
a main body part which has a loading part and an accommodating part and which has a lateral opening, the loading part being a space to load the transported object, the accommodating part being located under the loading part, the accommodating part being a space to accommodate the bringing-in/bringing-out part such that the bringing-in/bringing-out part is at least partially surrounded from lateral sides;
a traveling device disposed on the main body part; and
a transferring device, which is disposed above the loading part of the main body part, for transferring the transported object loaded on the loading part to the bringing-in/bringing-out part or for transferring the transported object brought out from the bringing-in/bringing-out part to the loading part, with the bringing-in/bringing-out part accommodated in the accommodating part.

2. The transporting carrier according to claim 1, wherein said transferring device has:
a holding device for holding the transported object; and
a hoisting device for hoisting said holding device.

3. The transporting carrier according to claim 1, further comprising a safety catching device, which is disposed under the loading part of the main body part, for preventing the transported object from falling from the loading part by supporting the transported object loaded on the loading part from a lower side.

4. The transporting carrier according to claim 3, wherein said safety catching device is disposed in the accommodating part and is stored at a position at which said safety catching device does not obstruct the accommodation of the bringing-in/bringing-out part when the bringing-in/bringing-out part is accommodated in the accommodating part.

5. The transporting carrier according to claim 1, wherein said transferring device can be rotated in a horizontal direction with respect to the main body part.
